(19) United States
(12) Patent Application Publication
(10) Pub. No.: US 2014/0152615 A1
(43) Pub. Date: Jun. 5, 2014

(54) CAPACITIVE TOUCH PANEL

(71) Applicant: WINTEK CORPORATION, Taichung City (TW)

(72) Inventors: Ting-Yu Chang, Kaohsiung City (TW); Kuo-Chang Su, Tainan City (TW); Shiao-Hui Liao, Taichung City (TW); Ching-Fu Hsu, Taichung City (TW); Kun-Chang Ho, Taichung City (TW); Fa-Chen Wu, Taichung City (TW)

(73) Assignee: WINTEK CORPORATION, Taichung City (TW)

(21) Appl. No.: 14/097,293

(22) Filed: Dec. 5, 2013

(30) Foreign Application Priority Data
Dec. 5, 2012 (TW) 101145742

(51) Int. Cl. G06F 3/044

(52) U.S. Cl. CPC G06F 3/044
USPC 345/174

(57) ABSTRACT

A capacitive touch panel including a substrate and a plurality of approach sensing units disposed on the substrate is provided. Each approach sensing unit comprises a first driving electrode, a second driving electrode, a first sensing electrode unit and a second sensing electrode unit. The first and second driving electrodes are arranged in parallel along an axis. The first and second sensing electrode units are arranged along an axis and sense the approach of an object to generate a first approach sensing signal and a second approach sensing signal, respectively. The first and second sensing electrode units are adjacent to each other and disposed between the first and second driving electrodes or the first and second driving electrodes are adjacent to each other and disposed between the first and second sensing electrode units.

This application claims the benefit of Taiwan application Serial No. 101145742, filed Dec. 5, 2012, the subject matter of which is incorporated herein by reference.

### BACKGROUND OF THE INVENTION

1. Field of the Invention

The invention relates in general to a touch panel, and more particularly to a capacitive touch panel.

2. Description of the Related Art

When a single-layer capacitive touch panel is touched by a finger, major far-field lines of electric force will be induced by finger resulting in the variation of the capacitance. Since the capacitance induced by far-field lines of electric force is far less than the capacitance induced by near-field lines of electric force, the capacitance variation of the sensing circuit is little and is hard to detect.

Moreover, most conventional single-layer capacitive touch panels only have single touch function, and may malfunction when the conventional single-layer capacitive touch panels are interfered by noises.

### SUMMARY OF THE INVENTION

The invention is directed to a capacitive touch panel capable of providing multi-touch function, filtering off noises and reducing malfunction by changing the electrode patterns and the driving method of the driving circuit and the sensing circuit and using the calculation of the differential circuit.

The invention is directed to a capacitive touch panel capable of making the capacitance variation sensed by the sensing circuit be easily detected and increasing the signal-to-noise ratio (SNR) by changing the electrode patterns and the driving method of the driving circuit and the sensing circuit.

According to one embodiment of the present invention, a capacitive touch panel, comprising a substrate and a plurality of approach sensing units disposed on the substrate is provided. Each approach sensing unit comprises a first driving electrode, a second driving electrode, a first sensing electrode unit and a second sensing electrode unit. The first and second driving electrodes are arranged in parallel along an axis. The first sensing electrode unit is disposed on one side of the first driving electrode and senses the approach of an object to generate a first approach sensing signal. The second sensing electrode unit is disposed on one side of the second driving electrode and senses the approach of the object to generate a second approach sensing signal. The first and second sensing electrode units are adjacent to each other and disposed between the first and second driving electrodes or the first and second driving electrodes are adjacent to each other and disposed between the first and second sensing electrode units.

The above and other aspects of the invention will become better understood with regard to the following detailed description of the preferred but non-limiting embodiment(s). The following description is made with reference to the accompanying drawings.

### BRIEF DESCRIPTION OF THE DRAWINGS

FIG. 1 shows a schematic diagram of a capacitive touch panel according to an embodiment of the invention;

FIG. 2 shows a schematic diagram of an approach sensing unit used in a detection circuit;

FIG. 3 shows a schematic diagram of a capacitive touch panel according to an embodiment of the invention;

FIG. 4 shows a distribution diagram of lines of electric force;

FIG. 5 shows a schematic diagram of an approach sensing unit used in a detection circuit.

### DETAILED DESCRIPTION OF THE INVENTION

The capacitive touch panel of the embodiment senses the approach of an object by using a plurality of sensing electrodes arranged between two driving electrodes or a plurality of sensing electrodes arranged on two opposite sides of two driving electrodes such that at least one of the sensing electrodes generates an approach sensing signal.

A number of embodiments are disclosed below for elaborating the invention. However, the embodiments of the invention are for detailed descriptions only, not for limiting the scope of protection of the invention.

### First Embodiment

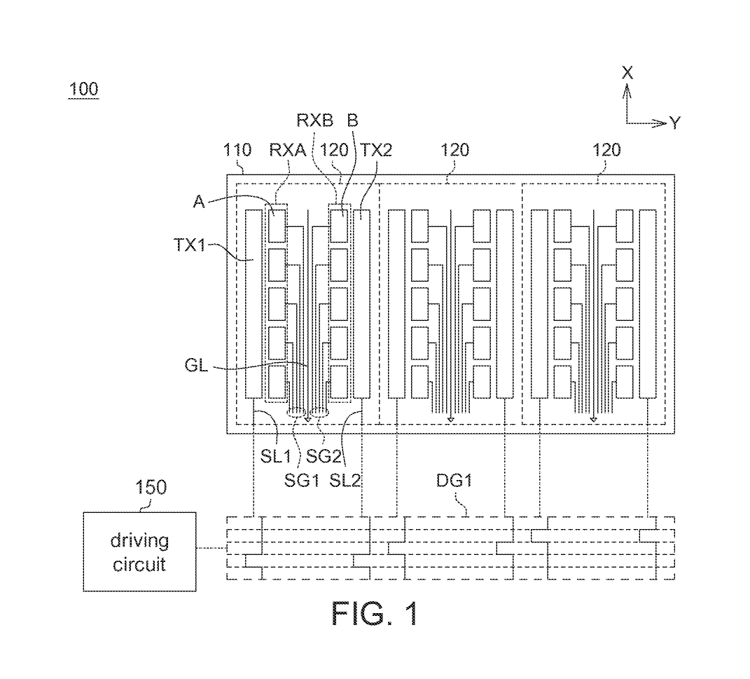

Referring to FIG. 1, a schematic diagram of a capacitive touch panel 100 according to an embodiment of the invention is shown. Let a single-layer capacitive touch panel be taken for example. The single-layer capacitive touch panel comprises a substrate 110 and a plurality of approach sensing units 120. The substrate 110 can be formed by glass or plastics. The approach sensing units 120 are formed on the substrate 110 and sense the approach of an object (such as a finger) to generate an approach sensing signal. The sensing signal can be capacitance variation, for example. Each approach sensing unit 120 includes a first driving electrode TX1, a second driving electrode TX2, a first sensing electrode unit RXA and a second sensing electrode unit RXB. The first sensing electrode unit RXA and the second sensing electrode unit RXB are adjacent to each other and disposed between the first driving electrode TX1 and the second driving electrode TX2. The first sensing electrode unit RXA further includes a plurality of first sensing electrodes A. The second sensing electrode unit RXB further includes a plurality of second sensing electrodes B. In each approach sensing unit 120, the first sensing electrodes A and the second sensing electrodes B have the same quantity of sensing electrodes.

In the present embodiment, the sensing electrode unit is formed by a plurality of block type sensing electrodes. In another embodiment, the sensing electrode unit can be formed by a strip type electrode. The strip type electrode generates an impedance variation. Then, a detection circuit calculates a sensing variation voltage to obtain a capacitance variation at a touch position. In the present invention, the implementations of the sensing electrode unit are therefore not limited thereto.

The first driving electrode TX1 and the second driving electrode TX2 are two strip type electrodes arranged in parallel along an axis (such as coordinate X axis). The driving circuit 150 can input a driving signal DG1 to the first driving electrode TX1 and the second driving electrode TX2 through two signal lines SL1˜SL2 connected to the first driving electrode TX1 and the second driving electrode TX2, respectively. The driving signal DG1 is a pair of synchronous pulse scan signals. As indicated in FIG. 1, the scan signals are inputted to each of the approach sensing units 120 respectively.

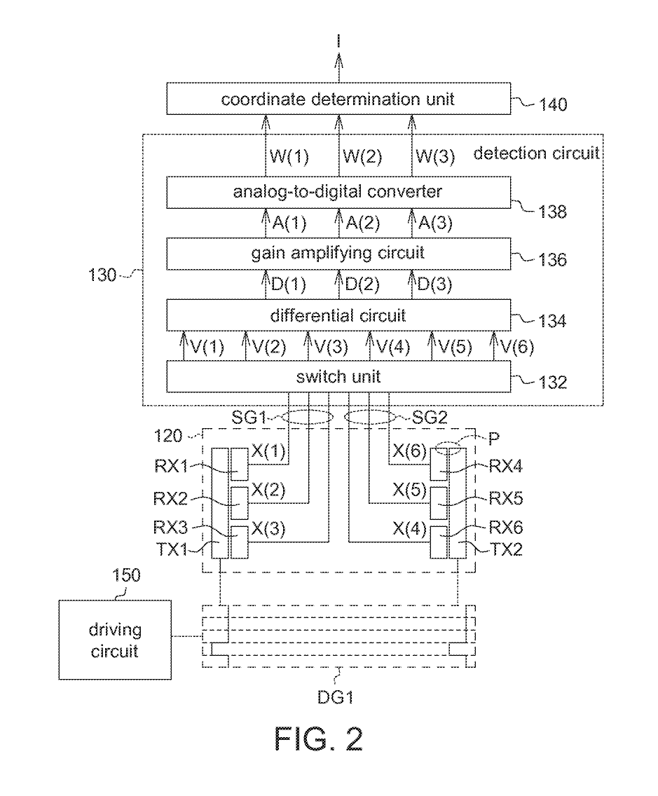

The first sensing electrode unit RXA, such as a block type electrode or a strip type electrode, is disposed on one side of the first driving electrode TX1 along an axis and separated from the first driving electrode TX1 by a suitable distance. The first sensing electrode unit RXA senses the approach of an object to generate a first approach sensing signal. Before the object (such as a finger) approaches the first sensing electrode unit RXA, lines of electric force are uniformly distributed between the first sensing electrode unit RXA and the first driving electrode TX1, and a sensing voltage is generated accordingly. Conversely, when the object (such as a finger) approaches the first sensing electrode unit RXA, lines of electric force are not uniformly distributed at the touch position, and a sensing variation voltage is generated accordingly. Meanwhile, each sensing electrode A of the first sensing electrode unit RXA can be connected to the outside detection circuit 130 (FIG. 2) through the inside first signal line group SG1, and the detection circuit 130 calculates the sensing variation voltage to obtain the capacitance variation at the touch position.

Similarly, the second sensing electrode unit RXB, such as a block type electrode or a strip type electrode, is disposed on one side of the second driving electrode TX2 along an axis and separated from the second driving electrode TX2 by a suitable distance. The second sensing electrode unit RXB senses the approach of an object to generate a second approach sensing signal. As mentioned above, each sensing electrode B of the second sensing electrode unit RXB can be connected to the outside detection circuit 130 (FIG. 2) through the inside second signal line group SG2, the detection circuit 130 is used to calculate the sensing variation voltage to obtain the capacitance variation at the touch position.

As indicated in FIG. 1, the first signal line group SG1 and the second signal line group SG2 are disposed at the inner side of each approach sensing unit 120, that is, between the first driving electrode TX1 and the second driving electrode TX2, such that the peripheral space of the substrate 110 can be relatively reduced, and narrow board effect can thus be achieved.

Also, the approach sensing unit 120 further has a dividing electrode GL disposed between the first sensing electrode unit RXA and the second sensing electrode unit RXB to avoid signal interference occurring between the first sensing electrode unit RXA and the second sensing electrode unit RXB. Preferably, the dividing electrode GL is connected to a ground potential.

Referring to FIG. 2, a schematic diagram of an approach sensing units 120 used in a detection circuit 130 is shown. The structure and layout of the approach sensing unit 120 of FIG. 2 are already disclosed above, and the similarities are not repeated here. The detection circuit 130 comprises a switch unit 132, a differential circuit 134, a gain amplifying circuit 136 and an analog-to-digital converter 138. When the first driving electrode TX1 and the second driving electrode TX2 are driven synchronously and the approach sensing units 120 sense the approach of an object P to generate approach sensing signal, the first sensing electrodes RX1˜RX3 transmit the sensing signals X(1)˜X(3) to the switch unit 132 of the detection circuit 130 through the first signal line group SG1, and the second sensing electrodes RX4˜RX6 transmit the sensing signals X(4)˜X(6) to the switch unit 132 of the detection circuit 130 through the second signal line group SG2. The switch unit 132 uses a multiplexer or a switch to selectively turn on a group of sensing signals X(1)˜X(6) and selectively turn off the signal lines connected to other sensing electrodes.

The selected group of sensing signals X(1)˜X(6) is outputted through the switch unit 132 as the first group of voltage signals V(1)˜V(6). The differential circuit 134 calculates the difference between the electrodes at two opposite positions of the voltage signals V(1)˜V(6) and further converts the difference into multiple differential signals D(1)˜D(3), wherein D(1)=V(1)−V(6), D(2)=V(2)−V(5), D(3)=V(3)−V(4). When the value of one of the differential signals D(1)˜D(3) is not equal to 0, this indicates that the detection circuit 130 detects the object approaches and makes the capacitance vary. As indicated in FIG. 2, when the object approaches the sensing electrode RX4 at the top right corner, the capacitance at the touch position varies, such that the differential signal D(1) is not equal to 0 but the remaining differential signals D(2) and D(3) are equal to 0. The analogy can be applied to other touch positions.

After the differential signals D(1)˜D(3) generated by the differential circuit 134 are calculated, the coordinate determination unit 140 receives the differential signals D(1)˜D(3) and further converts the differential signals D(1)˜D(3) into a coordinate information I to determine the position by which the object approaches or touches the substrate. In the present embodiment, after the differential signals D(1)˜D(3) are converted into analog signals A(1)˜A(3) by a gain amplifier, the analog signals A(1)˜A(3) are further converted into digital signals W(1)˜W(3) by an analog-to-digital converter 138. Lastly, the digital signals W(1)˜W(3) are converted into a coordinate information I by a coordinate determination unit 140.

In another embodiment, the coordinate determination unit 140 can be directly connected to the differential circuit 134 to receive the differential signals D(1)˜D(3) without going through the process of gain amplification or analog-to-digital conversion. Lastly, the differential signals D(1)˜D(3) are converted into a coordinate information I by the coordinate determination unit 140.

As indicated in FIG. 2, the first sensing electrodes RX1˜RX3 and the second sensing electrodes RX4˜RX6 are arranged in pairs and disposed between the first driving electrode TX1 and the second driving electrode TX2 to form multiple pairs of differential electrodes. For example, the first sensing electrode RX1 and the second sensing electrode RX4 form a first differential electrode pair, the first sensing electrode RX2 and the second sensing electrode RX5 form a second differential electrode pair, and the first sensing electrode RX3 and the second sensing electrode RX6 form a third differential electrode pair. Since the equivalent circuits between each pair of differential electrodes and a driving electrode are the same, the differential circuit 134, when calculating the differential signal, does not need to use complicated algorithm to compensate the mismatching generated when the circuits have resistance difference.

Moreover, the capacitive touch panel 100 of the present embodiment, driven in a differential manner, calculates capacitance variation at each touch position and reduces the interference of noise coming from the display panel under the touch panel 100, such that the capacitive touch panel 100 of the present embodiment is capable of providing multi-touch function, filtering off noises and reducing error actions.

### Second Embodiment

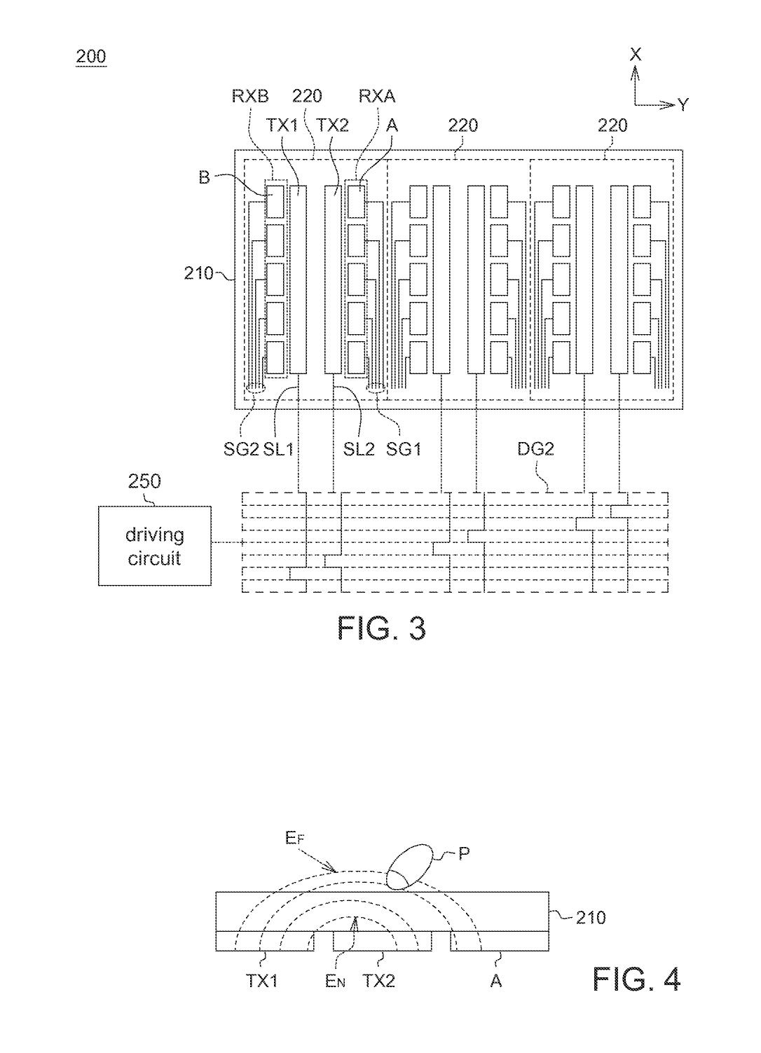

Referring to FIG. 3, a schematic diagram of a capacitive touch panel 200 according to an embodiment of the invention is shown. The capacitive touch panel 200 comprises a substrate 210 and a plurality of approach sensing units 220. The substrate 210 can be formed by glass or plastics. The approach sensing units 220 are formed on the substrate 210 for sensing the approach of an object (such as a finger) to generate an approach sensing signal. The sensing signal can be capacitance variation. The first driving electrode TX1 and the second driving electrode TX2 are adjacent to each other and disposed between the first sensing electrode unit RXA and the second sensing electrode unit RXB. The first sensing electrode unit RXA further includes a plurality of first sensing electrodes A. The second sensing electrode unit RXB further includes a plurality of second sensing electrodes B. In each approach sensing unit 220, the first sensing electrodes A and the second sensing electrodes B have the same quantity of sensing electrodes.

The first driving electrode TX1 and the second driving electrode TX2 are two strip type electrodes arranged in parallel along an axis (such as coordinate X axis). The driving circuit 250 can input a driving signal DG2 to the first driving electrode TX1 and the second driving electrode TX2 through two signal lines SL1˜SL2 connected to the first driving electrode TX1 and the second driving electrode TX2, respectively. The driving signal DG2 is a pair of non-synchronously pulse scan signals. As indicated in FIG. 3, the scan signals are inputted to the approach sensing units 220 at different timings, respectively.

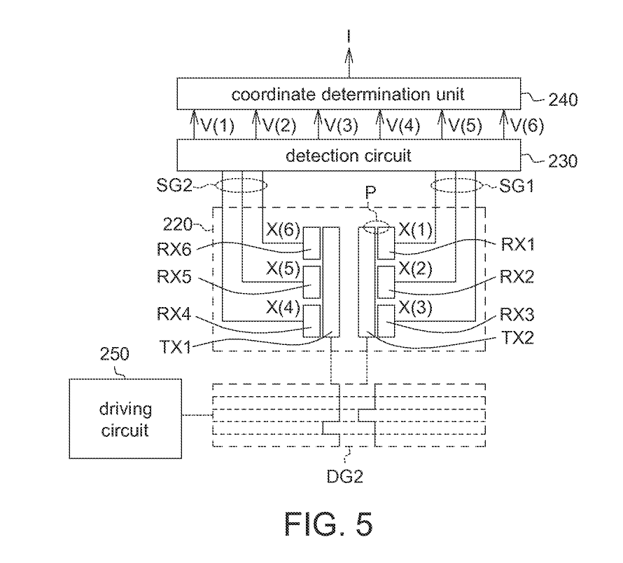

When the object (such as a finger) approaches an electrode A of the first sensing electrode unit RXA, each of the electrodes A can be connected to the outside detection circuit 230 (FIG. 5) through the outside first signal line group SG1, and the detection circuit 230 is used to calculate the sensing variation voltage to obtain the capacitance variation at the touch position. Similarly, when the object (such as a finger) approaches an electrode B of the second sensing electrode unit RXB, each of the electrodes B can be connected to the detection circuit 230 (FIG. 5) through the second signal line group SG2, and the detection circuit 230 is used to calculate the sensing variation voltage to obtain the capacitance variation at the touch position.

As indicated in FIG. 3, the first sensing electrode unit RXA, such as a block type electrode or a strip type electrode, is disposed on one side of the first driving electrode TX1 along an axis and senses the approach of an object to generate a first approach sensing signal. The present embodiment is different from the first embodiment in that: the first sensing electrode unit RXA and the first driving electrode TX1 are not adjacent to each other in the present embodiment. That is, the second driving electrode TX2 is disposed between the first driving electrode TX1 and the first sensing electrode unit RXA, such that the first sensing electrode unit RXA and the first driving electrode TX1 are not adjacent to each other. Likewise, the second sensing electrode unit RXB, such as a block type electrode or strip type electrode, is disposed on one side of the second driving electrode TX2 along an axis and senses the approach of an object to generate a second approach sensing signal. The present embodiment is different from the first embodiment in that: the second sensing electrode unit RXB and the second driving electrode TX2 are not adjacent to each other in the present embodiment. That is, the first driving electrode TX1 is disposed between the second driving electrode TX2 and the second sensing electrode unit RXB, such that the second sensing electrode unit RXB and the second driving electrode TX2 are not adjacent to each other.

Through the staggered arrangement disclosed above, near-field lines of electric force between the first sensing electrode unit RXA and the first driving electrode TX1 can be grounded by the second driving electrode TX2 and eliminated, and only far-field lines of electric force can be detected. Referring to FIG. 4, a distribution diagram of lines of electric force is shown. When a pulse scan signal is inputted to the first driving electrode TX1, a near-field lines of electric force E_{N} is generated between the first driving electrode TX1 and the second driving electrode TX2 adjacent to the first driving electrode TX1. Since the near-field lines of electric force E_{N} cannot pass over the substrate 210, the near-field lines of electric force E_{N} cannot be changed. Besides, a far-field lines of electric force E_{F} is generated between the first driving electrode TX1 and the first sensing electrodes A not adjacent to the first driving electrode TX1. Since the far-field lines of electric force E_{F} can pass over the substrate 210, the far-field lines of electric force E_{F} at the touch position will be changed and generate a sensing variation voltage when the object (such as a finger) approaches or touches the substrate 210. Meanwhile, since the voltage of the signal inputted to the second driving electrode TX2 is 0V, the capacitance variation (ΔC_{N}) sensed by the near-field lines of electric force E_{N} is short-circuited and becomes 0. Since the detection circuit 230 only needs to calculate the capacitance variation (ΔC_{F}) induced by the far-field lines of electric force E_{F} (that is, the capacitance variation (ΔC_{N}) induced by the near-field lines of electric force E_{N} is neglected), the capacitance variation can be easily detected and the signal-to-noise ratio (SNR) is increased accordingly.

Referring to FIG. 5, a schematic diagram of an approach sensing unit 220 used in a detection circuit 230 is shown. The structure and layout of the approach sensing unit 220 of FIG. 5 are already disclosed above, and the similarities are not repeated here. Capacitance variation can be calculated by using the detection circuit 230 such as the detection circuit 130 of the first embodiment or other means, and the calculation of capacitance variation in the present invention is not limited thereto. The driving method of the present embodiment is different that of the first embodiment in that: the second driving electrode TX2 is not driven when the first driving electrode TX1 is driven, such that the electrical potential of the second driving electrode TX2 maintains at about 0; the first driving electrode TX1 is not driven when the second driving electrode TX2 is driven, such that the electrical potential of the first driving electrode TX1 maintains at about 0. Therefore, when the approach sensing units 120 senses the approach of an object P to generate an approach sensing signal, the first sensing electrodes RX1˜RX3 transmit the sensing signals X(1)˜X(3) to the detection circuit 230 through the first signal line group SG1 when the first driving electrode TX1 is driven, and the second sensing electrodes RX4˜RX6 transmit the sensing signals X(4)˜X(6) to the detection circuit 230 through the second signal line group SG2 when the second driving electrode TX2 is driven. Then, the approach sensing signals generated by the first sensing electrodes RX1˜RX3 and the second sensing electrodes RX4˜RX6 are detected by the detection circuit 230. Then, the voltage signals V(1)˜V(6) outputted from the detection circuit 230 are converted into a coordinate information I by the coordinate determination unit 240.

According to the capacitive touch panel 200 of the present embodiment, two driving electrodes and their corresponding sensing electrode units are staggered with each other, such that the first driving electrode TX1 and its corresponding first sensing electrodes RX1˜RX3 are not adjacent to each other, and the second driving electrode TX2 and its corresponding second sensing electrodes RX4˜RX6 are not adjacent to each other either. Therefore, the detection circuit 230 can neglect capacitance variation (ΔCN) induced by near-field lines of electric force and only needs to calculate the capacitance variation (ΔCF) induced by far-field lines of electric force, and the SNR can thus be increased.

While the invention has been described by way of example and in terms of the preferred embodiment(s), it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A capacitive touch panel, comprising:
a substrate; and
a plurality of approach sensing units disposed on the substrate, wherein each approach sensing unit comprises:
a first driving electrode;
a second driving electrode arranged in parallel with the first driving electrode along an axis;
a first sensing electrode unit which is disposed on one side of the first driving electrode and senses the approach of an object to generate a first approach sensing signal; and
a second sensing electrode unit which is disposed on one side of the second driving electrode and senses the approach of the object to generate a second approach sensing signal;
wherein, the first sensing electrode unit and the second sensing electrode unit are adjacent to each other and disposed between the first and second driving electrodes or the first and second driving electrodes are adjacent to each other and disposed between the first sensing electrode unit and the second sensing electrode unit.

2. The capacitive touch panel according to claim 1, wherein the first sensing electrode unit comprises a plurality of first sensing electrodes arranged along the axis, the second sensing electrode unit comprises a plurality of second sensing electrodes arranged along the axis, and the first sensing electrodes and the second sensing electrodes have the same quantity of sensing electrodes.

3. The capacitive touch panel according to claim 2, wherein the first sensing electrodes and the second sensing electrodes are arranged in pairs and disposed between the first driving electrode and the second driving electrode to form a plurality of differential electrode pairs.

4. The capacitive touch panel according to claim 1, wherein when the first driving electrode and the second driving electrode are adjacent to each other, the second driving electrode is disposed between the first driving electrode and the first sensing electrode unit, and the first driving electrode is disposed between the second driving electrode and the second sensing electrode unit.

5. The capacitive touch panel according to claim 1, further comprising a detection circuit which is connected to the first sensing electrode unit and the second sensing electrode unit and detects the first and second approaching sensing signals generated by the first sensing electrode unit and the second sensing electrode unit respectively.

6. The capacitive touch panel according to claim 5, wherein the detection circuit comprises a differential circuit which is connected to the first sensing electrode unit and the second sensing electrode unit respectively and calculates a differential signal according to the first approach sensing signal and the second approach sensing signal.

7. The capacitive touch panel according to claim 6, further comprising a coordinate determination unit which is connected to the differential circuit and receives and convert the differential signal into a coordinate information.

8. The capacitive touch panel according to claim 5, further comprising a coordinate determination unit which is connected to the detection circuit and receives and converts an output signal outputted from the detection circuit into a coordinate information.

9. The capacitive touch panel according to claim 1, further comprising a driving circuit which is connected to the first driving electrode and the second driving electrode and synchronously inputs a signal to drive the first driving electrode and the second driving electrode.

10. The capacitive touch panel according to claim 1, further comprising a driving circuit which is connected to the first driving electrode and the second driving electrode, the second driving electrode is not driven when the first driving electrode is driven, and the first driving electrode is not driven when the second driving electrode is driven.

11. The capacitive touch panel according to claim 1, wherein the substrate further comprises a first signal line group and a second signal line group which are connected to the first sensing electrode unit and the second sensing electrode unit respectively.

12. The capacitive touch panel according to claim 11, wherein each approach sensing unit further comprises a dividing electrode disposed between the first sensing electrode unit and the second sensing electrode unit when the first sensing electrode unit and the second sensing electrode unit are adjacent to each other.
